(19) United States
(12) Patent Application Publication
(10) Pub. No.: US 2020/0345181 A1
(43) Pub. Date: Nov. 5, 2020

(54) PORTABLE BLENDER

(71) Applicant: Modern Comfort Home Products LLC, Wyckoff, NJ (US)

(72) Inventors: Stephen J. Potaki, Wyckoff, NJ (US); Lourdes R. Potaki, Wyckoff, NJ (US)

(21) Appl. No.: 16/863,580

(22) Filed: Apr. 30, 2020

Related U.S. Application Data
(60) Provisional application No. 62/841,381, filed on May 1, 2019.

(51) Int. Cl. A47J 43/046; A47J 43/07; B01F 15/00

(52) U.S. Cl. CPC A47J 43/046; B01F 15/00688; B01F 15/00519; A47J 43/0722

(57) ABSTRACT

A portable blender is provided, the portable blender having a substantially cylindrical or conical base and a substantially cylindrical or conical blending chamber. A blade assembly is rotatably fixed within the blending chamber, and a motor is provided for rotating the blade, the motor being located within the base. A battery assembly for powering the motor is located within the base. The battery assembly has several substantially cylindrical battery cells arranged in a semicircular configuration and located adjacent an outer wall of the base.

### CROSS-REFERENCE TO RELATED APPLICATION

This application claims the benefit of U.S. Provisional Application No. 62/841,381, filed on May 1, 2019, the contents of which are incorporated by reference herein.

### FIELD

The present disclosure generally relates to a portable blender.

### BACKGROUND

Food and drink blenders are typically plugged into a power outlet in order to generate enough power to blend even the hardest consumable, such as frozen food and/or ice. The effectiveness of portable housewares and appliances that rely on battery power is usually related to the type and capacity of the battery. However, certain appliances are not particularly suited to being portable and transportable as the power requirement is usually too severe for effective operation.

Blenders typically require substantial amounts of power, and therefore portable blenders typically fail to function as well as plug in blenders. USB powered blenders exist, but typically lack sufficient battery capacity and use insufficient motors for power. Without a motor capable of delivering sufficient blending power, portable blenders cannot consistently break ice and other hard foods as well as plug in blenders can. Further, more powerful motors are not an option unless battery capacity can be increased.

There is a need for a portable blender that is portable and transportable and that can operate on enough power to blend even the hardest consumable, such as frozen food and/or ice.

### SUMMARY

An embodiment of the present disclosure provides a portable blender, comprising: a base; a blade rotatably connected to the base; and a battery configured to supply power to rotate the blade with enough power to blend even the hardest consumable, such as frozen food and/or ice.

A portable blender according to this disclosure typically comprises a substantially cylindrical or conical base, a substantially cylindrical or conical blending chamber, and a blade assembly rotatably fixed within the blending chamber for blending items placed within the chamber.

A motor is provided within the base of the portable blender for rotating the blade assembly located within the blending chamber, and a battery assembly is provided within the base for powering the motor. The battery assembly comprises a plurality of substantially cylindrical battery cells arranged in a semicircular configuration and located adjacent an outer wall of the base.

In some embodiments, the base takes the form of a truncated cone and has a truncated conical surface, where the surface has a concave profile, thereby resulting in a bell shape.

In some embodiments, the battery assembly has an upper and lower bracket for positioning each of the battery cells in the semicircular configuration, and the lower bracket comprises a heat sink for cooling the battery cells. In such an embodiment, the battery assembly is located above vents in a bottom surface of the base.

In some embodiments, the blade assembly comprises a fixation mechanism at a rotational axis of the blade assembly for fixing the blade assembly to a drive mechanism, a first pair of blades extending in opposite directions from the rotational axis, and a second pair of blades extending in opposite directions from the rotational axis.

The first pair of blades and the second pair of blades typically have different characteristics. The first pair of blades is typically symmetric about the rotational axis and the second pair of blades is typically asymmetric about the rotational axis.

The fixation mechanism is typically in a central planar blade segment, and the central planar blade segment is at a first height. The second pair of blades typically comprises a first blade having a first planar blade segment at a second height different than the first height and a second blade having a second planar blade segment at a third height different than the first height or the second height.

In some embodiments, the first planar blade segment ends in a blade tip and the second planar blade segment ends in an angled blade segment and the angled blade segment of the second blade ends in a blade tip.

The first blade and the second blade of the second pair may extend to different radial distances from the rotational axis. The blade tip of the first blade may therefore extend to a different radial distance than the blade tip of the second blade.

In some embodiments, the first pair of blades each have an angled blade segment angled upwards from the central blade segment, and each angled blade segment ends in a blade tip. The angled blade segment may then trace a radial circle when the blade assembly is rotated about the rotational axis. Each angled blade segment may then be canted relative to a tangent of the radial circle.

Further the radial circle traced by the blade tips of the first blade pair may be different than the radial circle traced by the first blade tip of the second pair or the radial circle traced by the second blade tip of the second pair. As such, the four blades of the blade assembly may trace three distinct radial circles.

In some embodiments, at least one blade of the blade assembly has a sharpened edge and at least one blade of the blade assembly has a serrated edge. In some such embodiments, the blades of the first pair have serrated blade edges and the blades of the second pair have sharpened edges.

In some embodiments, the blade assembly described is provided independent of the battery assembly described. Further, while the blade assembly is described in terms of a portable blender, the blade assembly may be used in a non-portable blender as well.

### BRIEF DESCRIPTION OF THE DRAWINGS

FIGS. 1, 2A, 2B, and 2C illustrate perspective views of a portable blender according to one embodiment.

FIGS. 3A-3D illustrate side views of a portable blender according to one embodiment.

FIGS. 3E and 3F respectively illustrate a top view and a bottom view of a portable blender according to one embodiment.

FIG. 4 shows a sectioned view of the base of the portable blender of FIG. 1 with the container attached.

FIG. 5 shows a view of the base of the portable blender of FIG. 1 with a housing removed.

FIGS. 6A-C show top and side views of a blade assembly for use in the portable blender of FIG. 1.

FIGS. 7A-F show perspective, front, back, top, and bottom views of a battery assembly for use in the portable blender of FIG. 1.

FIG. 7G shows a sectioned top view of the battery assembly of FIG. 7A.

FIG. 7H shows an exploded view of the battery assembly of FIG. 7A.

### DETAILED DESCRIPTION OF THE PREFERRED EMBODIMENTS

The description of illustrative embodiments according to principles of the present disclosure is intended to be read in connection with the accompanying drawings, which are to be considered part of the entire written description. In the description of embodiments of the disclosure disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the exemplified embodiments. Accordingly, the disclosure expressly should not be limited to such exemplary embodiments illustrating some possible non-limiting combination of features that may exist alone or in other combinations of features; the scope of the disclosure being defined by the claims appended hereto.

This disclosure describes the best mode or modes of practicing the disclosure as presently contemplated. This description is not intended to be understood in a limiting sense, but provides an example of the disclosure presented solely for illustrative purposes by reference to the accompanying drawings to advise one of ordinary skill in the art of the advantages and construction of the disclosure. In the various views of the drawings, like reference characters designate like or similar parts.

It is important to note that the embodiments disclosed are only examples of the many advantageous uses of the innovative teachings herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality.

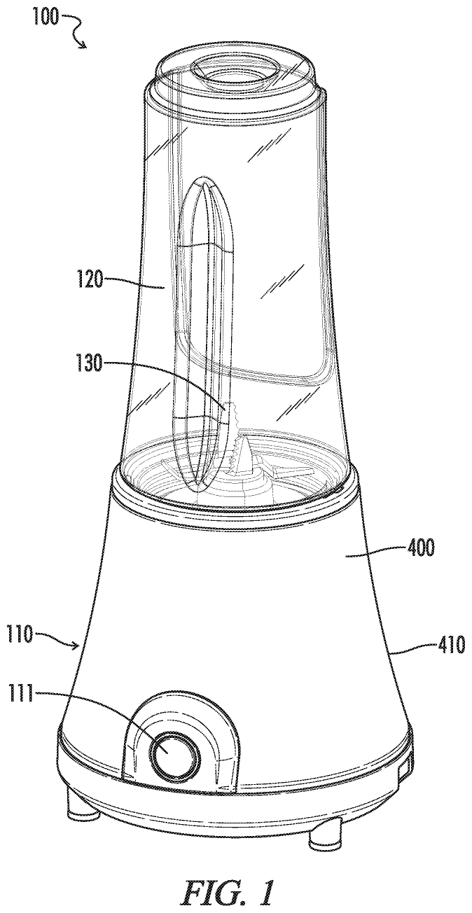

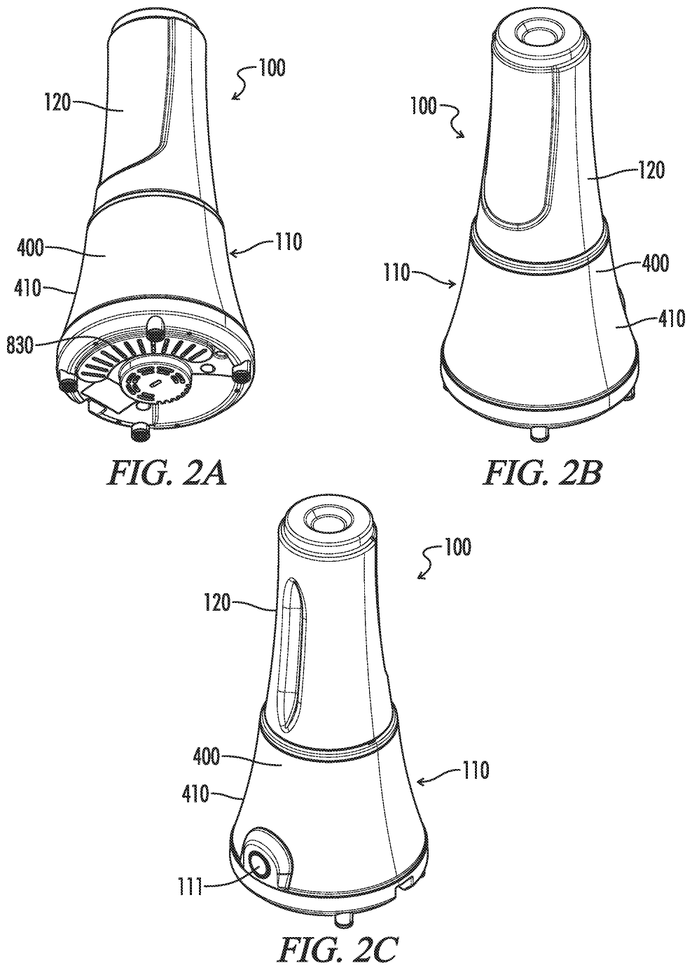

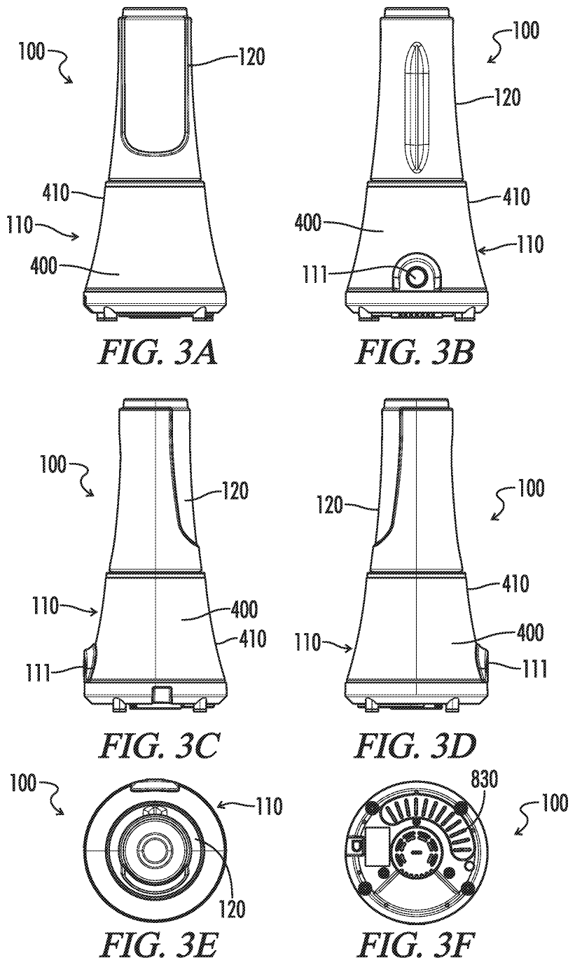

FIGS. 1, 2A, 2B, and 2C illustrate perspective views of a portable blender 100 according to one embodiment. FIGS. 3A-3D illustrate side views of the portable blender 100. FIGS. 3E and 3F respectively illustrate a top view and a bottom view of the portable blender 100.

The portable blender 100 shown in FIG. 1 may be used to crush, chop, mix, shred, or blend material. In particular, the portable blender 100 may have a unique battery assembly 140 and blade assembly 130 that allows the blender 100 to crush even the hardest consumables, such as frozen food and/or ice. The portable blender 100 may include a base 110, a container 120, and the blade assembly 130. The base 110 may include an on/off switch 111 for rotation of the blade assembly 130. The switch 111 may be disposed on a side of the base 110. The blade assembly 130 may be rotatably connected to the base 110. The container 120 may be configured to attach to the base 110, and may accommodate the blade assembly 130.

The container 120 may be configured to hold material to be chopped, mixed, shredded or blended by the blade assembly 130. The material may include, but not limited to, fruits, vegetables, nuts, grains, meats, eggs, cheese, spices, other food or food products, drinkable liquids, frozen food, ice, or other edible ingredients.

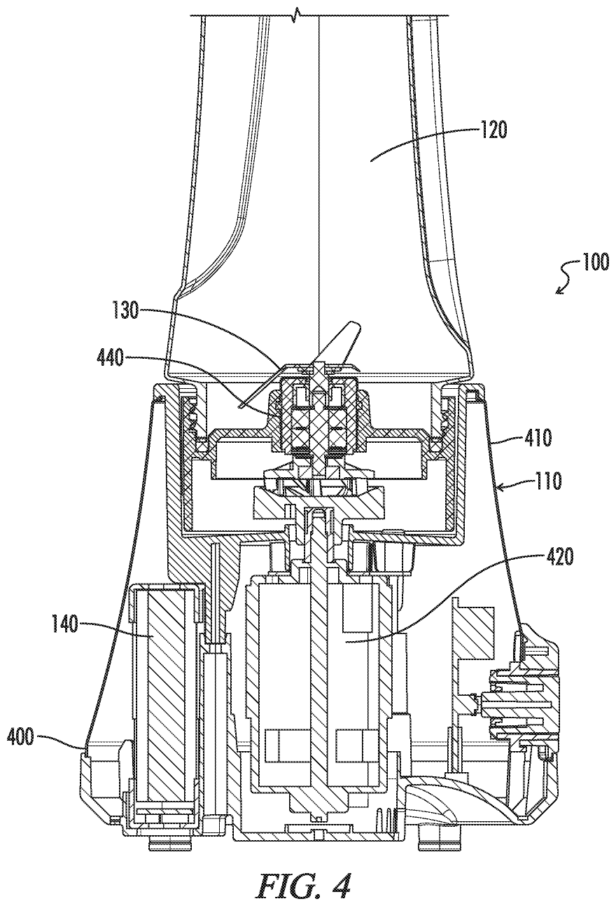

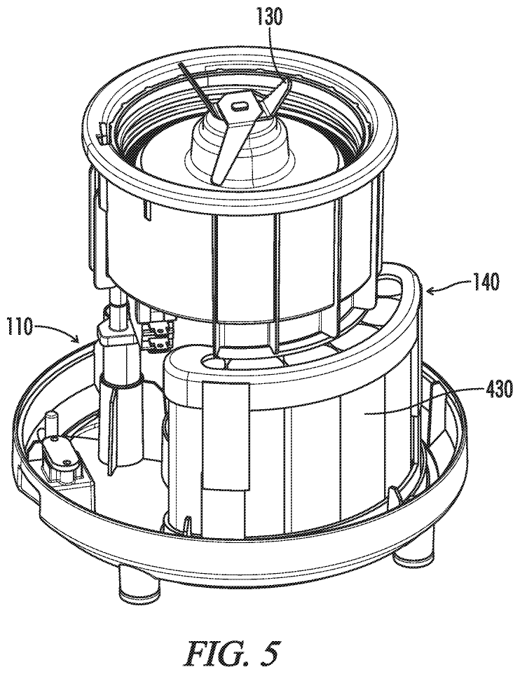

FIG. 4 shows a sectioned view of the base 110 of the portable blender 100 of FIG. 1 with the container 120 attached. FIG. 5 shows a perspective view of the base 110 of the portable blender 100 of FIG. 1 with the housing removed.

The portable blender 100 typically comprises a substantially cylindrical or conical base 110, or a base shaped in some combination thereof. For example, the base 110 may be bell shaped, as in the embodiment shown. As shown, the base 110 has a housing 400 which may take the form of a truncated cone. As such a surface 410 of the truncated conical housing 400 may have a concave profile.

The portable blender 100 typically further comprises a blending chamber, or container 120, which may be similarly cylindrical or conical. In some embodiments, such as that shown, the housing 400 of the base 110 and the container may form a single cylindrical or conical shape, including an extended bell shape, when combined.

The portable blender 100 further comprises a blade assembly 130 rotatably fixed within the blending chamber 120 and a motor 420 for rotating the blade assembly 130 is located within the base 110. Further, the battery assembly 140 for powering the motor 420 is fixed within the base 110. As shown, and as discussed in more detail below, the battery assembly 140 for powering the motor 420 comprises a plurality of substantially cylindrical cells 430 arranged in a semicircular configuration. The battery assembly 140 is then located adjacent an outside wall 410 of the base 110 of the portable blender 100.

When in use, the blending chamber 120 is removably fixed to the base 110 of the portable blender 100. When the blending chamber 120 is on the base 110, the motor 420 in the base rotates the blade assembly 130 by way of a linkage 440.

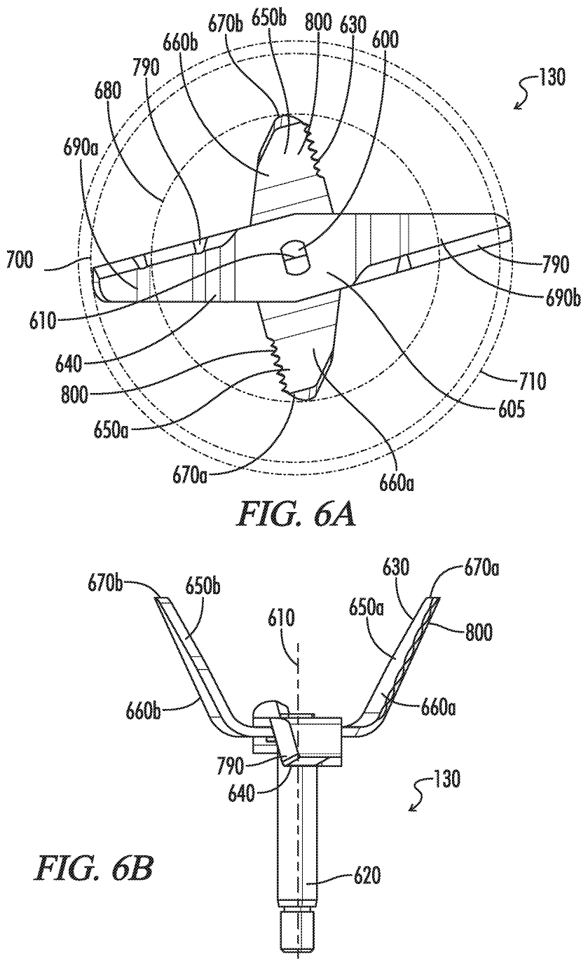

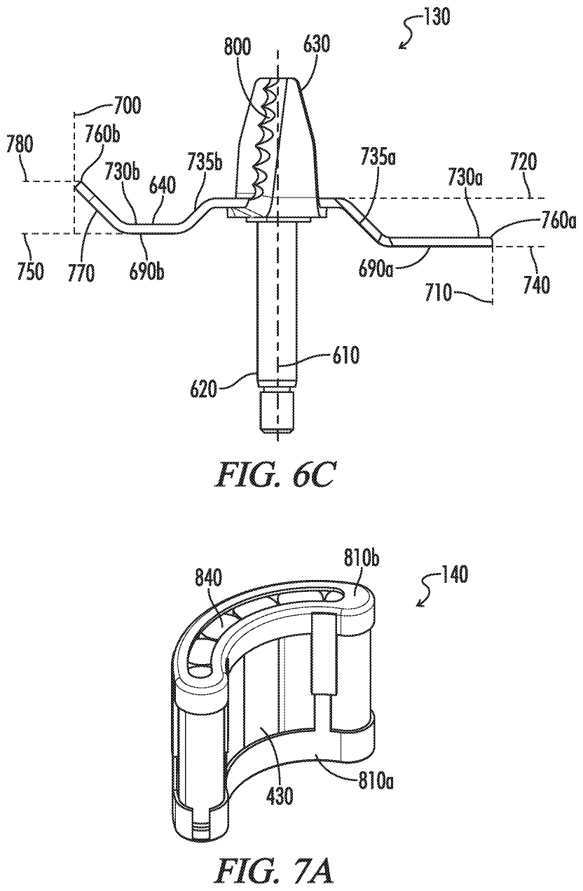

FIGS. 6A-C show top and side views of a blade assembly 130 for use in the portable blender 100 of FIG. 1. The blade assembly 130 has a fixation mechanism 600 located at a rotational axis 610 of the blade assembly for fixing the blade assembly to a drive mechanism. The fixation mechanism 600 may be a hole at a center point of the blade assembly, with the hole being shaped to accept a drive shaft 620. Alternatively, the drive shaft 620 may be permanently fixed to the blade assembly 130, and may form part of the fixation mechanism 600. The fixation mechanism 600 may then be rotated by way of the linkage 440.

The fixation mechanism 600 is typically located centrally at a central planar blade segment 605. The blade assembly 130 has a first pair of blades 630 extending in opposite directions from the rotational axis 610 and a second pair of blades 640 extending in opposite directions from the rotational axis. The second pair of blades 640 are substantially perpendicular to the first pair of blades 630. Generally, as shown, the first pair of blades 630 are symmetric while the second pair of blades 640 are asymmetric about the rotational axis 610.

The first pair of blades 630 typically has a first blade 650a and a second blade 650b which are symmetric about the rotational axis 610. As shown, the blades 650a, b of the first pair of blades 630 each have an angled blade segment 660a, b angled upwards from the central blade segment 605. The angled blade segment ends in a blade tip 670a, b, and upon rotation of the blade assembly 130 about the rotational axis 610, the blade tips trace a circle 680 at a first radial distance from the rotational axis.

As shown, the angled blade segment 660a, b of each of the blades 650a, b of the first pair 630 are canted relative to a tangent of the circle 680 at the first radial distance. This results in a force pushing any food products in the container 120 outwards during rotation of the first pair of blades 630. Typically, the angled blade segments 660a, b are canted 15-16 degrees relative to the tangent of the circle 680. However, more aggressive or less aggressive cant angles are possible.

The second pair of blades 640 has a first blade 690a and a second blade 690b extending from the central planar blade segment 605. As shown, the blades 690a, b of the second pair 640 are asymmetric, and as such the first blade 690a traces a circle 700 at a second radial distance from the rotational axis 610 and the second blade 690b traces a circle 710 at a third radial distance from the rotational axis. The first, second, and third radial distances are different, and as such the circles 700, 710 traced by the two blades 690a, b of the second pair 640 are different than the circle 680 traced by the blades 650a, b of the first pair 630.

As shown in FIG. 6C, among others, the fixation mechanism 600 is located in the central planar blade segment 605 and is located at a first height 720. The blades 690a, b of the second pair 640 each have a respective planar blade segment 730a, b, and the planar blade segment 730a of the first blade 690a is at a height 740 different than a height 750 of the planar blade segment 730b of the second blade 690b. Further, the heights 740, 750 of the planar blade segments 730a, b of the second pair 640 are different than the height 720 of the central planar blade segment 605. In this way, the three planar blade segments 605, 730a, b are at three distinct heights 720, 740, 750. As shown, the heights 740, 750 of the planar blade segments 730a, b may be below the height 720 of the central planar blade segment 605.

Further, the first blade 690a of the second pair 640 has a transitional angled blade segment 735a between the central planar blade segment 605 and the first planar blade segment 730a. Similarly, the second blade 690b of the second pair 640 has a transitional angled blade segment 735b between the central planar blade segment 605 and the second planar blade segment 730b. As shown, the first angled blade segment 735a and the second angled blade segment 735b may be at the same angle relative to the planar blade segments 605, 730a, b. As shown, the second planar blade segment 730b is at a height 750 higher than the first planar blade segment 730b, such that the height 750 of the second planar blade segment 730b is closer to the height 720 of the central planar blade segment 605 than the height 740 of the first planar blade segment 730a. In such an embodiment, the second planar blade segment 730b may begin further radially from the central planar blade segment 605 than the first planar blade segment 730a.

Further, as shown, the planar blade segment 730a of the first blade 690a ends in a blade tip 760a. In contrast, the planar blade segment 730b of the second blade 690b ends in an angled blade segment 770, and the angled blade segment ends in a blade tip 760b. In this way, the blade tip 760b of the second blade 690b is at a height 780 different than the first height 720, second height 730, or the third height 740. As discussed above, the blade tip 760a of the first blade 690a extends to a distance radially than the blade tip 760b of the second blade, and both blade tips 690a, b of the second pair 640 extend to different distances radially than either blade tip 670a, b of the first pair.

In some embodiments, at least one blade has a sharpened blade edge 790 and at least one blade has a serrated blade edge 800. In the embodiment shown, each blade 650a, b of the first pair 630 has a serrated blade edge 800 and each blade 690a, b of the second blade pair 640 has a sharpened blade edge 790

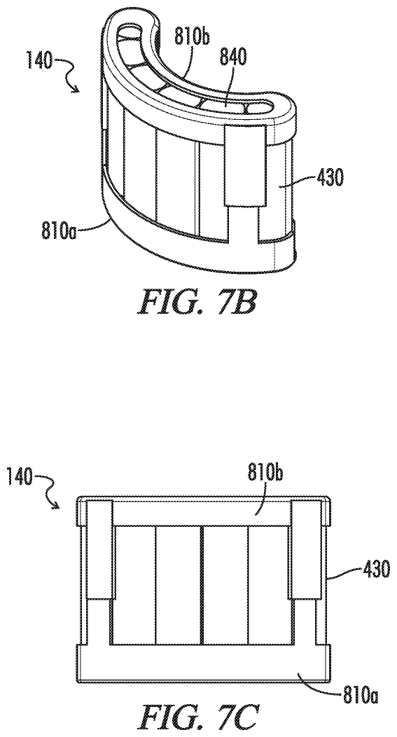

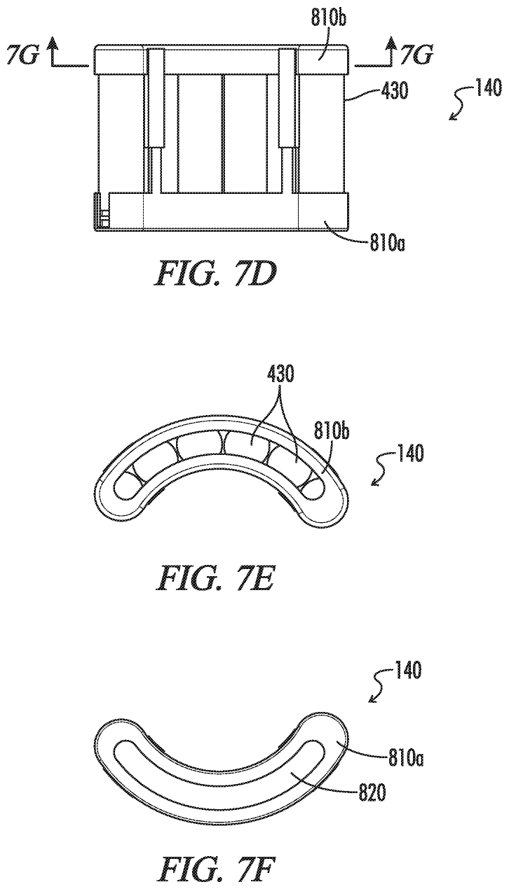

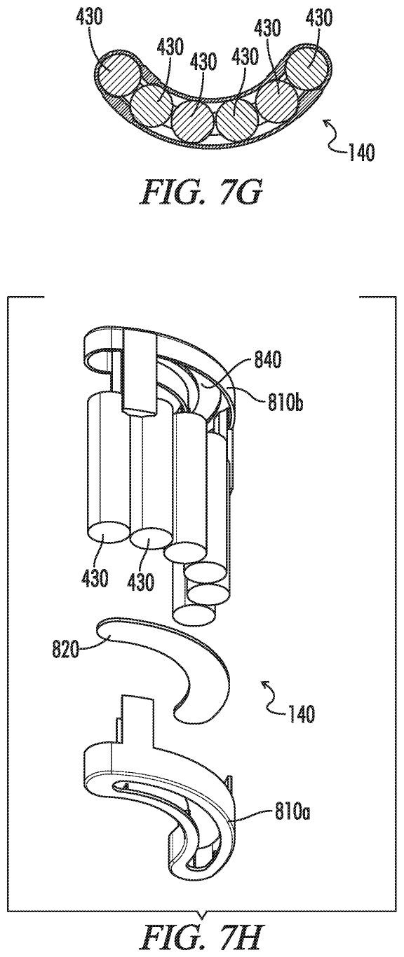

FIGS. 7A-F show perspective, front, back, top, and bottom views of a battery assembly 140 for use in the portable blender 100 of FIG. 1. FIG. 7G shows a sectioned top view of the battery assembly 140 of FIG. 7A, and FIG. 7H shows an exploded view of the battery assembly 140.

As shown, the battery assembly 140 has a plurality of substantially cylindrical battery cells 430 arranged in a semicircular configuration. The battery assembly 140 typically has an upper bracket 810a and a lower bracket 810b which combine to position each of the battery cells 420 in the semicircular configuration.

The lower bracket 810b may include circuitry 820 for managing the charging and discharging of each of the battery cells 420, and may further include a heat sink mechanism for directing heat generated by the cells 420 downwards. As such, the lower bracket 810b may be positioned directly above vents 830 in a bottom surface of the base 110 of the portable blender 100, and heat may be directed out the vents.

The upper bracket 810b may comprise an opening 840 exposing an end of each of the battery cells 420.

The semicircular configuration applied to the individual battery cells 420 by the upper and lower brackets 810a, b allows the battery assembly 130 to be located directly adjacent the cylindrical or conical outer walls 410 of the housing 400 of the base 110. Otherwise, significant dead space would exist between a traditionally shaped battery and the outer walls 410, and a smaller capacity battery would be required to fit a designated battery compartment space. The curved shape of the battery assembly 130 thereby allows for a higher capacity battery which can thereby power a more powerful motor 420 in the portable blender 100.

Because of the additional battery capacity made possible by the configuration shown, the motor 420 may have a higher motor speed, such as 15,500 RPM, allowing for quick and efficient blending of frozen foods. The motor may have a double ball bearing structure design, and may have a high efficiency (greater than 70%), thereby improving motor frequency and overall motor life and reducing power consumption and extending life of the battery pack.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A portable blender, comprising:
a substantially cylindrical or conical base;
a substantially cylindrical or conical blending chamber;
a blade assembly rotatably fixed within the blending chamber;
a motor for rotating the blade assembly located within the base; and
a battery assembly for powering the motor located within the base,
wherein the battery assembly comprises a plurality of substantially cylindrical battery cells arranged in a semicircular configuration and located adjacent an outer wall of the base.

2. The portable blender of claim 1, wherein the base is has a substantially conical and truncated surface, and wherein surface has a concave profile resulting in a partial bell shape.

3. The portable blender of claim 1, wherein the battery assembly further comprises an upper and lower bracket for positioning each of the battery cells in the semicircular configuration.

4. The portable blender of claim 3, wherein the lower bracket comprises a heat sink for cooling the battery cells, and wherein the battery assembly is located above vents in a bottom surface of the base.

5. The portable blender of claim 1, wherein the blade assembly comprises:
a fixation mechanism at a rotational axis of the blade assembly for fixing the blade assembly to a drive mechanism;
a first pair of blades extending in opposite directions from the rotational axis;
a second pair of blades extending in opposite directions from the rotational axis, the second pair of blades being substantially perpendicular to the first pair of blades,
wherein the first pair of blades is symmetric and the second pair of blades is not symmetric about the rotational axis.

6. The portable blender of claim 5, wherein the second pair of blades comprises a first blade and a second blade extending to different radial distances from the rotational axis.

7. The portable blender of claim 5, wherein the fixation mechanism is in a central planar blade segment at a first height, and the second pair of blades comprises a first blade having a first planar blade segment at a second height different than the first height and a second blade having a second planar blade segment at a third height different than the first height or the second height.

8. The portable blender of claim 7, wherein the first planar blade segment ends in a blade tip and the second planar blade segment ends in an angled blade segment, and where the angled blade segment ends in a blade tip.

9. The portable blender of claim 8, wherein the blade tip of the first blade of the second pair extends to a first radial distance and the blade tip of the second blade of the second pair extends to a second radial distance different than the first radial distance.

10. The portable blender of claim 5, wherein the fixation mechanism is in a central blade segment, and wherein the first pair of blades each have an angled blade segment angled upwards from the central blade segment, each angled blade segment ending in a blade tip, and wherein the angled blade segment traces a radial circle when the blade assembly is rotated about the rotational axis, and wherein the angled blade segment is canted relative to a tangent of the radial circle.

11. The portable blender of claim 5, wherein at least one blade has a sharpened blade edge and at least one blade has a serrated blade edge.

12. The portable blender of claim 11, wherein the first pair of blades comprise serrated blade edges and wherein the second pair of blades comprise sharpened blade edges.

13. A blade assembly for a blender comprises:
a fixation mechanism at a rotational axis of the blade assembly for fixing the blade assembly to a drive mechanism;
a first pair of blades extending in opposite directions from the rotational axis;
a second pair of blades extending in opposite directions from the rotational axis, the second pair of blades being substantially perpendicular to the first pair of blades,
wherein the first pair of blades is symmetric and the second pair of blades is not symmetric about the rotational axis.

14. The blade assembly of claim 13, wherein the second pair of blades comprises a first blade and a second blade extending to different radial distances from the rotational axis.

15. The blade assembly of claim 13, wherein the fixation mechanism is in a central planar blade segment at a first height, and the second pair of blades comprises a first blade having a first planar blade segment at a second height different than the first height and a second blade having a second planar blade segment at a third height different than the first height or the second height.

16. The blade assembly of claim 15, wherein the first planar blade segment ends in a blade tip and the second planar blade segment ends in an angled blade segment, and where the angled blade segment ends in a blade tip.

17. The blade assembly of claim 16, wherein the blade tip of the first blade of the second pair extends to a first radial distance and the blade tip of the second blade of the second pair extends to a second radial distance different than the first radial distance.

18. The blade assembly of claim 13, wherein the fixation mechanism is in a central blade segment, and wherein the first pair of blades each have an angled blade segment angled upwards from the central blade segment, each angled blade segment ending in a blade tip, and wherein the angled blade segment traces a radial circle when the blade assembly is rotated about the rotational axis, and wherein the angled blade segment is canted relative to a tangent of the radial circle.

19. The blade assembly of claim 13, wherein at least one blade has a sharpened blade edge and at least one blade has a serrated blade edge.

20. The blade assembly of claim 19, wherein the first pair of blades comprises serrated blade edges and wherein the second pair of blades comprises sharpened blade edges.
